(19) United States
(12) Patent Application Publication
(10) Pub. No.: US 2021/0374589 A1
(43) Pub. Date: Dec. 2, 2021

(54) STANDARDIZED METHOD OF QUANTUM STATE VERIFICATION BASED ON OPTIMAL STRATEGY

(71) Applicant: Nanjing University, Nanjing (CN)

(72) Inventors: XIAOSONG MA, NANJING (CN); XINHE JIANG, NANJING (CN); KUN WANG, NANJING (CN); KAIYI QIAN, NANJING (CN); LIANGLIANG LU, NANJING (CN)

(73) Assignee: Nanjing University

(21) Appl. No.: 17/060,089

(22) Filed: Oct. 1, 2020

(30) Foreign Application Priority Data
May 29, 2020 (CN) 202010475173.4

(51) Int. Cl. G06N 10/00; H04B 10/70

(52) U.S. Cl. CPC G06N 10/00; H04B 10/70

(57) ABSTRACT

The invention discloses a standardized method of quantum state verification based on optimal strategy. The specific steps are as follows: (1) Adjust the quantum device to generate the quantum states required; (2) Calculate the measurement basis under the optimal verification strategy; (3) The quantum device generates the quantum state copy by copy, and the optimal measurement basis is performed for each copy. The measurement results are recorded as 1 for success and 0 for failure; (4) Make statistics on the index of first failure N_{first} and the number of success events mₚₐₛₛ in N measurements; (5) Estimate the confidence and fidelity of the target state generated by the equipment according to the statistical results, and evaluate and analyze the reliability of the equipment. The invention realizes the standardized verification of the reliability of the quantum device, and estimates the quantum state with fewer resources.

### CROSS-REFERENCE TO RELATED APPLICATIONS

This application claims priority to Chinese Patent Applications No. CN202010475173.4, filed on May 29, 2020. The content of the aforementioned applications, including any intervening amendments thereto, are incorporated herein by reference.

### TECHNICAL FIELD

This disclosure generally belongs to the field of quantum state verification in quantum information, and specifically relates to the standardization of an optimal verification strategy in the reliable test of actual quantum equipment.

### BACKGROUND

Quantum equipment for generating quantum states is an important module in quantum information technology, which is used to generate single-particle states and multi-particle entangled states and widely used in quantum communication, quantum simulation, quantum computing and other fields. Now there are many mature quantum devices for generating quantum states, which are applied to various fields of quantum communication and quantum computing.

Checking whether a quantum equipment can reliably and effectively generate the quantum state required by the customer is an important step towards the large-scale application of quantum devices. As an end user, after receiving the quantum equipment, his/her hope is to adjust its parameters to generate the quantum state that he/she needs. But in actual application scenarios, the device structure is not 100% perfect, and there will be various noises in operation, which will cause the quantum state actually generated by the device to be different from the target state needed by the customer. The goal of the customer is to use as few resources as possible to determine with a certain confidence that the device has produced the target state within a certain fidelity.

The traditional standardized method for characterizing quantum states generated by a quantum equipment is quantum state tomography. However, as the number of particles and qubits increases, the number of measurement bases required for quantum state tomography increases exponentially. In addition, it requires tens of thousands of copies of quantum states. To reduce statistical errors, the maximum likelihood estimation is also used to obtain the density matrix in the data post-processing. Due to the large amount of measurement settings and data required for processing, this method is very time-consuming and resource-consuming.

In recent years, some non-tomographic methods have been proposed to verify the quantum state. They do not need to know the exact density matrix of the quantum state. They can estimate the quantum state with a specific confidence level and fidelity level. However, these methods either make some specific assumptions about the quantum state or restrict specific measurement operations, which are not easy to implement in practical applications. So far, no unified standardized method like quantum state tomography has been established.

To this end, we have established a standardized quantum state verification procedure by which to verify the quantum device with optimal strategy. This procedure is universal and can be used for the verification of quantum products for generating quantum states in the future.

### SUMMARY

In order to overcome the shortcomings of traditional quantum state tomography, the invention provides a set of standardized procedures for quantum state verification based on optimal verification strategies, standardizes the schemes for quantum state verification, and fully and efficiently analyzes quantum equipment. The technical scheme is as follows:

A standardized method of quantum state verification based on optimal strategy, including the following specific steps:

(1) Generating target state: Regarding different physical ensembles such as ions, superconductors, photons, NV color centers, etc., adjusting the various components of the quantum equipment to generate the target state required by the customer.

Firstly optimize the phase of each module, monitoring the contrast of each channel in the standard base through the coincidence counts detected by the single photon detector, and adjust the phase to maximize the contrast in the standard base. The target state can be generated by adjusting the relative intensity and phase of different components in the quantum state.

According to the form of the target state |ψ(r,ϕ) [symbol] required by the customer, adjust the different components in the quantum equipment so that the corresponding intensity and relative phase of the generated state are close to the target intensity and phase set by the customer, such that the device can work in the target state.

(2) Obtain the projective measurement required by the optimal strategy: Calculate the density matrix corresponding to the target state |ψ(r,ϕ) [symbol] by programming, so as to obtain the estimated values of the parameters r and ϕ in the target state.

For a general entangled state, the theory gives the projective measurement required by the optimal strategy. The measurement basis is related to the values of r and ϕ in the target state. The values of the parameters r and ϕ estimated above can be used to calculate the measurement basis corresponding to the projective measurement. The measurement basis is realized by a quantum state analyzer, which can perform both the non-adaptive and adaptive measurements. The adaptive measurement is realized using triggering instrument.

In practice, selecting multiple sets of parameters r and ϕ for the target state, then writing an automated calculation program. For each given target state, the settings corresponding to the measurement bases in the quantum state analyzer can be obtained through the parameters r and ϕ.

(3) Realization of projective measurement: The quantum state is measured by the state analyzer. This method uses both non-adaptive measurement and adaptive measurement, and the two measurements cooperate to realize a comprehensive evaluation for the quantum equipment.

Taking the two particle systems A and B as an example. Non-adaptive measurement does not require communication between A and B, and each performs local projective measurement. Adaptive measurement requires classical communication between A and B. The result of one party is transmitted to the other party in real time, and the triggering instrument of the other party is controlled to switch to the corresponding measurement base, so as to realize the adaptive measurement with the help of classical communication.

The analyzer finally uses the time-correlated counter to detect the particle, and records the coincidence count of each channel during the measurement. The timestamp of each detection channel is obtained through the timetag technology in the optimal projective measurement basis. Writing a data processing program to separate and extract the coincidence counts during a specific time window from the timetag file. Under each projective measurement basis, the strategy will have a success probability corresponding to specific coincidence counts. If the projection occurs at two successful coincidence channels within the coincidence window, the measurement result is recorded as success 1, otherwise recorded as failure 0.

(4) Statistics on the measurement results: Based on the optimal verification strategy, this invention method uses two cooperative mechanisms to ensure the reliability of verification.

Task A: Select the projective base from the measurement sets sequentially. Each measurement is randomly selected according to the probability of the projective base. The final measurement results constitute a binary string 1111110 . . . , and record the position of the first failure event 0 as N_{first}, and each N_{first} has a probability of occurrence Pr (N_{first}), the cumulative probability of success for the previous nₑₓₚ measurements is:

$${δ}_{A} = {\sum }_{{N}_{first} = 1}^{{n}_{exp}} Pr ( {N}_{first} )$$

This gives the confidence of the target state generated by the device, and a desired confidence level δ_{A} can be taken to obtain the required number of measurements nₑₓₚ, which is the number of copies of quantum states consumed to reach the δ_{A} confidence level.

Task B: Do a fixed number of measurements N, the statistical results of the measurements form a binary string 110101110 . . . 1, from which the number of success events mₚₐₛₛ is obtained. In theory, there will be a success probability μ≡1−Δ_{∈} related to the infidelity E of the target state. According to the relative magnitude of mₚₐₛₛ and μ, the equipment is classified into two cases, Case 1 (mₚₐₛₛ>μN) and Case 2 (mₚₐₛₛ<μN), which belong to the inner region and the outer region of a circle with radius ∈, respectively. The confidence of the equipment can be upper bounded using the Chernoff bound:

$$δ ≡ {e}^{- ND ( \frac{{m}_{pass}}{N} \vert \vert μ )}$$

where

$$D ( x \vert \vert y ) := x {log}_{2} ( \frac{x}{y} ) + ( 1 - x ) {log}_{2} ( \frac{1 - x}{1 - y} )$$

is the Kullback-Leiber divergence. Finally, the confidence of δ_{B}=1−δ can be used to determine whether the device belongs to Case 1 or Case 2.

(5) Estimation and analysis of the confidence and fidelity: For task A, the copy index of quantum state where the first failure occurs constitutes a geometric distribution. N_{first}=nₑₓₚ means that the previous nₑₓₚ−1 measurements are successful, while the nₑₓₚ-th measurement fails. The calculated cumulative probability is the confidence that the device generates the target state. Therefore, the number of measurements nₑₓₚ obtained is the number required to generate the confidence δ_{A}. At the same time, one can estimate the infidelity ∈ₑₓₚ^{Non} and ∈ₑₓₚ^{Adp} of the state produced by the device by fitting the geometric statistics of probability distribution. These infidelities corresponds to the estimation of the infidelity of the quantum state obtained by non-adaptive and adaptive measurement, respectively.

For task B, a reasonable value of E based on the above fitted ∈ₑₓₚ^{Non} and ∈ₑₓₚ^{Adp} and a fixed value of δ are given. According to the formula of Chernoff bound, programming and calculating the variation of δ and ∈ along with the increase of the number of copies of quantum states, and finally obtain the number of copies required for the confidence to be δ_{B} and the scaling law of E versus N.

The advantages of this invention are that:

1. Compared with the traditional quantum state tomography method, the present invention requires fewer measurement bases. For example, for a qubit system, non-adaptive measurement requires four measurement bases, and adaptive measurement only requires three measurement bases. Moreover, the number of copies of the quantum state consumed is small, and a reliable estimation of the quantum state can be made with relatively fewer copies. With the same number of copies, the present method can achieve better accuracy than traditional quantum state tomography.

2. Compared with the existing quantum state verification and estimation schemes, the present invention provides a standardized workflow, relaxes the strong assumptions in the original theoretical scheme. Considering the imperfect operation of the actual equipment, a comprehensive discussion of its possible working conditions was given, which has a good practical and applicable prospect, and it could be used as a standardized method for checking the quantum equipment.

3. The data post-processing is simple and easy, and requires only simple programming (such as matlab, mathematica, python, etc.) to get the variation trend of the confidence and fidelity with the number of measurements. In terms of the estimation of physical parameters, the scaling of ∈ versus N (∈˜N^{r}) can approach the Heisenberg limit of r=1.

### BRIEF DESCRIPTION OF THE DRAWINGS

Various embodiments in accordance with the present disclosure will be described with reference to the drawings, in which:

FIG. 1 illustrates the schematic diagram of the working principle of quantum state verification for the invention.

FIG. 2 illustrates the verification workflow of the invention.

FIG. 3 illustrates the data acquisition and processing of task A in the invention.

FIG. 4 illustrates the data acquisition and processing of task B in the invention.

FIG. 5 illustrates the setup of a verification example in the invention.

FIG. 6 illustrates the adaptive measurement implementation of the invention.

### DETAILED DESCRIPTION

In order to make the objectives, technical schemes and advantages of the present invention clearer, the present invention will be further described below in conjunction with the accompanying drawings and specific implementation examples. It should be noted that the specific embodiments described here are only used to explain the present invention, but not to be limited to the present invention.

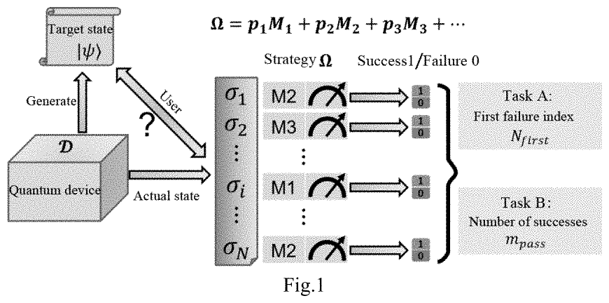

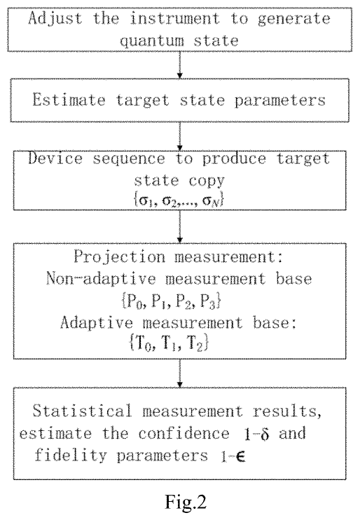

As shown in FIG. 1, taking the photon system as an example, a quantum state verification principle based on the optimal strategy is given. The end user expects the quantum device to output the target state |ψ [symbol] . In actual working, the device is not perfect, and some states σ₁ [symbol] σ₂ [symbol] . . . [symbol] σᵢ [symbol] . . . [symbol] σ_{N} that deviate from the target state will be generated in N times of measurement. These states are called the copies of the target state. For each copy σᵢ of the target state, the projective measurement base Mᵢ is randomly selected from the measurement sets {M₁, M₂, M₃, . . . } with the corresponding selection probability pᵢ. Then the measurement Mᵢ is performed and the measurement result is recorded as 1 for success and 0 for failure. The workflow of the verification is shown in FIG. 2.

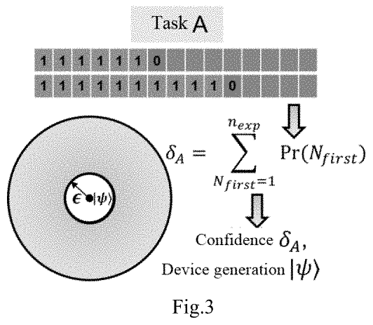

Present invention uses two cooperative tasks to verify the quantum device. As shown in FIG. 3, task A counts the index of copies N_{first} where the first failure occurs. It is based on the following assumption—the fidelity of the state σᵢ produced by the device and the target state of the device is either 1 or there is an infidelity ∈ which is greater than 0 and the fidelity satisfies [symbol] ψ|σᵢ|ψ [symbol] ≤1−∈ for all states σ₁. The goal of task A is to distinguish these two cases. Since the target state is always the eigenstate of the projective operator, it satisfies the test Mᵢ|ψ [symbol] =|ψ [symbol] . In the worst case, the fidelity of the state generated by the device is less than 1∈, and the maximum probability of a passing the test is:

$${max}_{( ψ \vert {σ}_{i} \vert ψ 〉 \leq 1 - ϵ} Tr ( Ω {σ}_{i} ) = 1 - [ 1 - {λ}_{2} ( Ω ) ] ϵ := 1 - {Δ}_{ϵ} \qquad ( 1 )$$

Among them, the measurement operator ψ=ΣᵢpᵢMᵢ is called a verification strategy, Δ_{∈}:=[1−λ₂(Ω)]∈ is the probability of failing a single test, and λ₂(Ω) is the second largest eigenvalue of the Ω measurement operator. After N rounds of tests, the maximum probability of σᵢ passing all tests in the worst case is (1−Δ_{E})^{N}. In order to obtain the confidence 1−δ, the minimum number of measurements required is:

$$N \geq ln δ / ln [ 1 - {Δ}_{ϵ} ] \approx \frac{1}{{Δ}_{ϵ}} ln \frac{1}{δ} \qquad ( 2 )$$

In order to minimize the consumption of measurement resources, the second largest eigenvalue λ₂(Ω) needs to be minimized. By optimizing the second largest eigenvalue, the projective measurement corresponding to the optimal strategy can be obtained, which is called non-adaptive measurement strategy [Phys. Rev. Lett. 120, 170502 (2018)]. For a qubit quantum state, non-adaptive measurement requires four measurement bases {P₀, P₁, P₂, P₃}.

In order to obtain the optimal verification strategy for any quantum state, a lemma is introduced: for any qubit state |104 [symbol] , if its optimal strategy is Ω, then a target state connected by a local unitary operation |φ [symbol] =(U⊗V)|ψ [symbol] has the optimal verification strategy Ω(φ)=(U⊗V)Ω(U⊗V)^{†}.

If classical communication is added, the number of measurements can be reduced. This is the optimal adaptive measurement strategy [Phys. Rev. A 100, 032315 (2019)]. Adaptive measurement requires real-time communication between particles A and B. Considering the one-way communication from particle A to particle B, only three measurement bases {T₀, T₁, T₂} are required. T₀ is still the usual Pauli matrix measurement, and the realization of T₁ and T₂ requires the selection of the measurement operations at B's site in real time based on the measurement results of A.

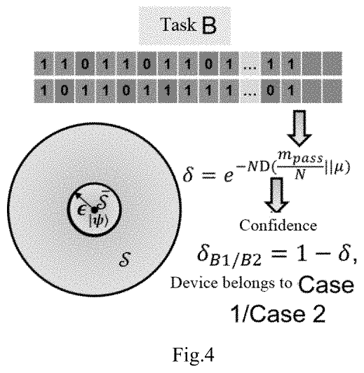

Considering that the actual equipment is not perfect, the more practical task (task B) is to give a threshold for the fidelity of the states produced by the device with a certain confidence. As shown in FIG. 4, considering two realistic situations, there exists a quantity ∈ greater than 0 such that:

Case 1: The equipment works correctly, and for any i, the fidelity satisfies [symbol] ψ|σᵢ|ψ [symbol] >1−∈.

Case 2: The equipment works incorrectly, and for any i, the fidelity is [symbol] ψ|σᵢ| [symbol] ≤1−∈.

For Case 1, there is a greater probability that the test will succeed and the number of successes is greater than the theoretical expectation. For Case 2, there is greater probability that the test will fail and the number of successes is less than the theoretical expectation. According to the distribution of the number of successes mₚₐₛₛ, whether the device belongs to Case 1 or Case 2 can be given with a certain probability.

Next, the specific procedures of verification are given based on the above principles, as shown in FIG. 2:

1. Adjust Quantum Devices to Produce the Desirable Quantum States

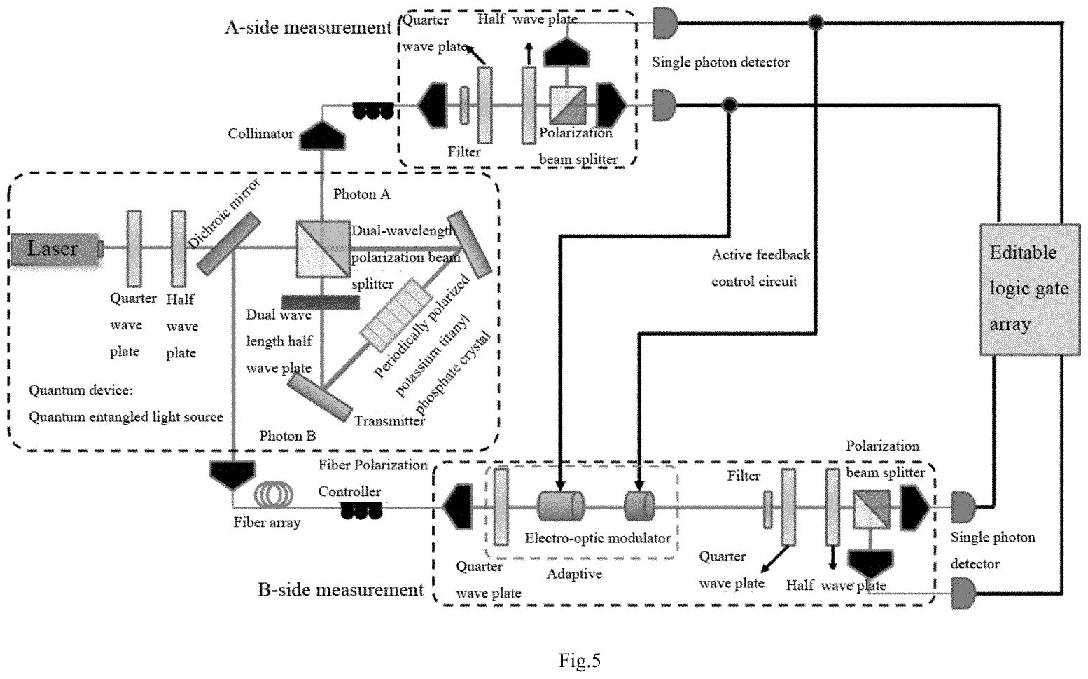

The quantum device has some tunable components for generating the required quantum state. As shown in FIG. 5, the quantum light source generates a two-photon polarization entangled state. The form of the target state is:

|ψ(θ,ϕ) [symbol] _{AB}=sin θ|HV [symbol] +cos θe^{iϕ}|VH [symbol] (3)

The quarter-wave plate and half-wave plate in the quantum light source can be adjusted to change the parameters θ and ϕ in the target state. The quantum light source pump periodically-poled potassium titanyl phosphate (PPKTP) crystals bidirectionally to generate the entangled photon pairs.

Parameterize the intensity parameter θ=k·π/10 in the target state, take some discrete points k=1,2,3,4 with equal intervals, adjust the wave plate so that coincidence counts of HV and VH conform to the weight ratio r=(sin θ/cos θ)². The density matrix of the quantum state is estimated by taking the count data accumulated for 1 second, and the optimized phase ϕ is obtained through this density matrix.

2. Measurement Bases of Optimal Verification Strategy

By minimizing the second largest eigenvalue λ₂(Ω) corresponding to the strategy Ω, the optimal measurement basis corresponding to the target state |ψ(θ, ϕ) [symbol] _{AB} can be obtained. The non-adaptive measurement has four projective measurements, one of which is the ZZ measurement (particles A and B are measured by Pauli σ_{Z} operator):

P₀=|H [symbol] [symbol] H|└|V∴ [symbol] V|+|V [symbol] [symbol] V|⊗|H [symbol] [symbol] H| (4)

The other three measurement bases Pᵢ=|ũᵢ [symbol] [symbol] ũᵢ|⊗|\tilde{v}ᵢ [symbol] [symbol] \tilde{v}ᵢ|, whose expressions are as follows:

$$\vert {\tilde{u}}_{1} 〉 = \frac{1}{\sqrt{1 + tan θ}} \vert H 〉 + \frac{{e}^{\frac{2 π i}{3}}}{\sqrt{1 + cot θ}} \vert V 〉 , \\ \vert {\tilde{v}}_{1} 〉 = \frac{1}{\sqrt{1 + tan θ}} \vert V 〉 + \frac{{e}^{π i / 3} {e}^{i ϕ}}{\sqrt{1 + cot θ}} \vert H 〉 . \\ \vert {\tilde{u}}_{2} 〉 = \frac{1}{\sqrt{1 + tan θ}} \vert H 〉 + \frac{{e}^{\frac{4 π i}{3}}}{\sqrt{1 + cot θ}} \vert V 〉 , \\ \vert {\tilde{v}}_{2} 〉 = \frac{1}{\sqrt{1 + tan θ}} \vert V 〉 + \frac{{e}^{5 π i / 3} {e}^{i ϕ}}{\sqrt{1 + cot θ}} \vert H 〉 . \\ \vert {\tilde{u}}_{3} 〉 = \frac{1}{\sqrt{1 + tan θ}} \vert H 〉 + \frac{1}{\sqrt{1 + cot θ}} \vert V 〉 , \\ \vert {\tilde{v}}_{3} 〉 = \frac{1}{\sqrt{1 + tan θ}} \vert V 〉 + \frac{{e}^{3 π i / 3} {e}^{i ϕ}}{\sqrt{1 + cot θ}} \vert H 〉 . \qquad ( 5 )$$

The expressions of the adaptive measurement bases {T₀, T₁, T₂} is in the following:

T₀=|H [symbol] [symbol] H|⊗|V [symbol] [symbol] V|+|V [symbol] [symbol] V|⊗|H [symbol] [symbol] H|

T₁=|+ [symbol] [symbol] +|⊗|\tilde{υ}₊ [symbol] [symbol] \tilde{υ}₊|+|− [symbol] [symbol] −|⊗|\tilde{υ}₋ [symbol] [symbol] \tilde{υ}₋|

T₂=|R [symbol] [symbol] R|⊗\tilde{ω}₊ [symbol] [symbol] \tilde{ω}₊|+|− [symbol] [symbol] −|⊗|\tilde{ω}₋ [symbol] [symbol] \tilde{ω}₋| (6)

where,

$$\vert + 〉 = \frac{\vert V 〉 + \vert H 〉}{\sqrt{2}} , \\ \vert - 〉 = \frac{\vert V 〉 - \vert H 〉}{\sqrt{2}} \\ \vert R 〉 = \frac{\vert V 〉 + i \vert H 〉}{\sqrt{2}} , \\ \vert L 〉 = \frac{\vert V 〉 - i \vert H 〉}{\sqrt{2}} \qquad ( 7 )$$

|\tilde{υ}₊ [symbol] =e^{iϕ} cos θ|H [symbol] +sin θ|V [symbol] ,|\tilde{υ}₋ [symbol] =e^{iϕ} cos θ|H [symbol] −sin θ|V

[symbol]

|\tilde{ω}₊ [symbol] =e^{iϕ} cos θ|H [symbol] −i sin θ|V [symbol] ,|\tilde{ω}₋ [symbol] =e^{iϕ} cos θ|H [symbol] +i sin θ|V [symbol] (8)

The expressions of the measurement bases are quantities related to the parameters (θ, ϕ) in the target state. Using the Jones matrix method, programming and calculating the setting parameters in the quantum state analyzer corresponding to the above-mentioned projective bases, and realizing the projective measurement for the polarized state.

3. Implementation of Projective Measurement

The device sequentially generates a series of copies of quantum states σᵢ. In FIG. 5, the dotted boxes at both ends of A and B are the measurements performed by the A and B photons. When the wave plate and electro-optic modulator components in the adaptive measurement are removed at the B's site, the non-adaptive measurement is performed. Non-adaptive measurement does not require classical communication. Using the parameters θ and ϕ of the target state, the angles of the quarter-wave plate and half-wave plate required to realize the projective measurement {P₀, P₁, P₂, P₃} can be calculated according to the expressions of |ũᵢ [symbol] and |\tilde{v}ᵢ [symbol] .

For adaptive measurement, B uses two electro-optic modulators to receive the measurement results of A in real time, so as to realize the projective measurement of \tilde{υ}₊\tilde{υ}₋ and \tilde{ω}₊/\tilde{ω}₋0 according to the measurement result of A. If the measurement result at A's site is |+ [symbol] or |R [symbol] , the former electro-optic modulator performs the corresponding rotation operation, and the latter electro-optic modulator maintains the identity matrix transformation. If the measurement result at A's site is |− [symbol] or |L [symbol] , the latter electro-optic modulator performs the corresponding rotation operation, and the former electro-optic modulator does the identity operation.

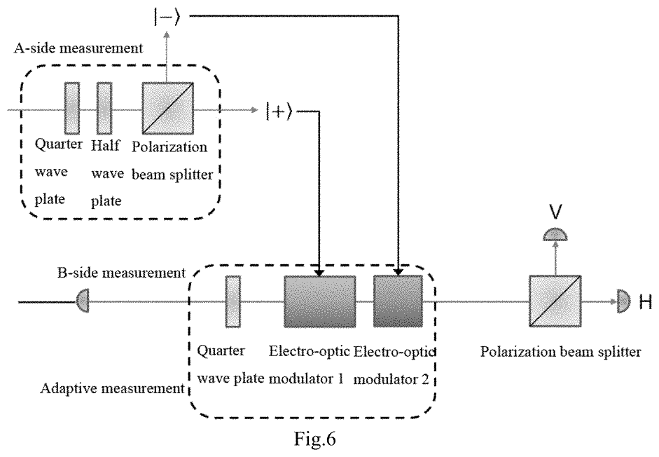

The implementation diagram of the adaptive measurement is shown in FIG. 6. Specifically, the electro-optic modulator 1 will convert the polarization states of \tilde{υ}₊ and \tilde{ω}₊ to the H polarization state, and finally exit from the transmission port of the polarized beam splitter (PBS) and enter the single photon detector. Correspondingly, \tilde{υ}₋ and \tilde{ω}₋ will be rotated by the electro-optic modulator 2 to the V polarization state and come out from the reflection port of the PBS. The measurement result of |+ [symbol] /R [symbol] at A's site is used to trigger the response of the electro-optic modulator 1 through the electrical signal, while the measurement result of |− [symbol] /L [symbol] is used to trigger the response of electro-optic modulator 2. Only one electro-optic modulator is active at a time, and the other electro-optic modulator performs identity operation. The specific operations of adaptive measurement are shown in the following table:

| | | | | Projective | |
|---|---|---|---|---|---|
| Measurement | Measurement | | | measurement | |
| setup | of A | Measurement of B | | results | Probability of success |
| T₀ | H | I (Electro- optic | I (Electro- optic | — | $\frac{{CC}_{H V} + {CC}_{V H}}{{CC}_{H V} + {CC}_{H H} + {CC}_{V V} + {CC}_{V H}}$ |
| | | modulator | modulator | | |
| | | 1) | 2) | | |
| | V | I | I | — | |
| | | (Electro- | (Electro- | | |
| | | optic | optic | | |
| | | modulator | modulator | | |
| | | 1) | 2) | | |
| T₁ | + | \tilde{υ}₊ (Electro- optic | I (Electro- optic | \tilde{υ}₊ → H | $\frac{{CC}_{+ {\tilde{υ}}_{+}} + {CC}_{- {\tilde{υ}}_{-}}}{{CC}_{+ {\tilde{υ}}_{+}} + {CC}_{+ {\tilde{υ}}_{-}} + {CC}_{- {\tilde{υ}}_{+}} + {CC}_{- {\tilde{υ}}_{-}}}$ |
| | | modulator | modulator | | |
| | | 1) | 2) | | |
| | − | I | \tilde{υ}₋ | \tilde{υ}₋ → V | |
| | | (Electro- | (Electro- | | |
| | | optic | optic | | |
| | | modulator | modulator | | |
| | | 1) | 1) | | |
| T₂ | R | \tilde{ω}₊ (Electro- optic | I (Electro- optic | \tilde{ω}₊ → H | $\frac{{CC}_{R {\tilde{ω}}_{+}} + {CC}_{L {\tilde{ω}}_{-}}}{{CC}_{+ {\tilde{ω}}_{+}} + {CC}_{R {\tilde{ω}}_{-}} + {CC}_{L {\tilde{ω}}_{+}} + {CC}_{L {\tilde{ω}}_{-}}}$ |
| | | modulator | modulator | | |
| | | 1) | 2) | | |
| | L | I | \tilde{ω}₋ | \tilde{ω}₋ → V | |
| | | (Electro- | (Electro- | | |
| | | optic | optic | | |
| | | modulator | modulator | | |
| | | 1) | 2) | | |

The failure probability for single non-adaptive measurement is Δ_{∈}=1−∈/(2+sin θ cos θ), which is greater than the failure probability of single adaptive measurement Δ_{∈}=1−∈/(2−sin² θ). Therefore, to achieve the same confidence level of 1−δ, the number of copies of adaptive measurement is less. That is to say, adaptive measurement consumes fewer number of copies of quantum states at the expense of allowing classical communication.

4. Statistics of Measurement Results, Data Extraction and Processing

The timetag data of single photon detector are extracted using the field programmable logic gate array. The file of timetag data is stored as two columns. The first column is the label of each detection channel, and the second column is the response time stamp of the corresponding detection channel. The processing program takes each time slice as a unit. The initial time is tᵢ=1. The time increases by gradually skipping to the next line and finally reaches the end time t_{f}. Once one coincidence count is found between the tᵢ and t_{f} rows, the corresponding coincidence channel is recorded and is treated as one copy of the quantum state. Next time starts with tᵢ=n, the coincidence counts are scanned from t_{f}=n+1 until the next coincidence count is found between tᵢ and t_{f}. This process is iterated until all single coincidence counts are separated, and finally the projective results of each copy of quantum state can be obtained.

The measurement base is selected randomly according to the random numbers and the statistics of measurement results are made. Success event is recorded as 1, and failure event is recorded as 0. For non-adaptive measurement, the probabilities that the four measurement bases {P₀, P₁, P₂, P₃} are selected are μ₀=(2−sin 2θ)/(4+sin 2θ), μ₁=μ₂=μ₃=(1−μ₀)/3, respectively. For adaptive measurement, the probabilities of {T₀, T₁, T₂} being selected are

$$\{ β ( θ ) , \frac{1 - β ( θ )}{2} , \frac{1 - β ( θ )}{2} \} ,$$

respectively, where β(θ)=cos² θ/(1+cos² θ). Whether success or failure of the measurement result can be determined according to the channel where the coincidence count occurs. For example, for non-adaptive measurement, the success probability of the four measurement bases is:

$${P}_{0} : \frac{{CC}_{HV} + {CC}_{VH}}{{CC}_{HH} + {CC}_{HV} + {CC}_{VH} + {CC}_{VV}} \\ {P}_{i} : \frac{{CC}_{{\tilde{u}}_{i} {\tilde{v}}_{i}^{⊥}} + {CC}_{{\tilde{u}}_{i}^{⊥} {\tilde{v}}_{i}} + {CC}_{{\tilde{u}}_{i}^{⊥} {\tilde{v}}_{i}^{⊥}}}{{CC}_{{\tilde{u}}_{i} {\tilde{v}}_{i}} + {CC}_{{\tilde{u}}_{i} {\tilde{v}}_{i}^{⊥}} + {CC}_{{\tilde{u}}_{i}^{⊥} {\tilde{v}}_{i}} + {CC}_{{\tilde{u}}_{i}^{⊥} {\tilde{v}}_{i}^{⊥}}} \qquad ( 9 )$$

Where i=1, 2, 3. For P₀ projective measurement, if the coincidence count occurs in CC_{HV} or CC_{VH}, σᵢ passes the test and the result is recorded as 1. Otherwise if the coincidence count falls on other channels, the test fails and the result is recorded as 0. For Pᵢ projective measurement, if a single coincidence count falls on

$${CC}_{{\tilde{u}}_{i} {\tilde{v}}_{i}^{⊥}} , \\ {CC}_{{\tilde{u}}_{i}^{⊥} {\tilde{v}}_{i}} or {CC}_{{\tilde{u}}_{i}^{⊥} {\tilde{v}}_{i}^{⊥}} ,$$

the measurement is recorded as success 1, otherwise measurement is recorded as failure 0. For adaptive measurement, the measurement results can also be obtained according to the probability of success under each projective measurement.

The number of copies of the quantum state are gradually increased by programming, and the binary sequence 11101001 . . . 1 is obtained through the result of the coincidence counts. The task A is performed and the index of the copy of quantum state is recorded. The first occurrence of 0 is labelled as N_{first}. To reduce statistical error, 10,000 rounds of repetitions are performed. The probability for the occurrence of N_{first} is obtained. The task B is then performed by fixing the total number of measurements N. Also, 1000 rounds of repetitions is averaged to reduce the statistical error. The number of success events is recorded to obtain the number mₚₐₛₛ in the N measurements.

5. Evaluate the Confidence and Fidelity of the Target State Generated by the Equipment

Through task A, the number of copies of the quantum state required to reach 90% confidence can be calculated. That is, using the probability Pr(N_{first}) of the first failure which occurs at N_{first}, the cumulative probability can be obtained:

δ_{A}=Σ_{N}_{_{first}}₌₁ⁿ^{ₑₓₚ}Pr(N_{first}) (10)

Setting δ_{A}=90%, the value of nₑₓₚ can be calculated.

At the same time, the infidelity of the quantum state, i.e. ∈ₑₓₚ^{Non} (non-adaptive) and ∈ₑₓₚ^{Adp} (adaptive), can be estimated by fitting the probability distribution of N_{first}. This estimated parameter is used as the foundation for selecting the ϵ parameter in task B. The theoretical expected success probability in task B is [symbol] =1−Δ_{∈}≡μ. By using the Chernoff bound formula:

$$δ ≡ {e}^{- ND ( \frac{{m}_{pass}}{N} \vert \vert μ )} \qquad ( 11 )$$

The device is classified as Case 1 or Case 2 by taking suitable E. Under Case 1, the expected number of success events mₚₐₛₛ≥Nμ. The above formula can be used to calculate the variation of confidence δ_{B}=1−δ with the number of copies of the quantum state. Under Case 2, the expected number of success events mₚₐₛₛ≤Nμ, and the variation of confidence in this region can also be obtained in the same way. When the confidence level 1−δ is given, the Chernoff bound can be used to calculate the variation of ϵ versus the number of copies of quantum state N to obtain a scaling law ∈˜N^{r} for the estimation of infidelity parameters.

For the estimation of the confidence parameter and the infidelity parameter, this invention can achieve a better confidence and a higher fidelity under the same number of copies of quantum state.

The invention discloses a quantum state verification standardization method based on an optimal strategy. The basic principles, main working procedures and advantages of the present invention are shown and described above. Those people skilled in the industry should understand that the invention is not limited by the above-mentioned embodiments. The above-mentioned embodiments and the specifications describe only the principles of the invention. Without departing from the spirit and scope of the invention, the present invention will have various changes and improvements.

The verification method disclosed in the present invention is not limited to the photonic system, nor is it limited to the number of photons. It is suitable for various quantum systems such as ions, superconductors, and semiconductors. It only needs to select different strategies corresponding to the system specified to achieve corresponding device verification based on different platforms. All these changes and improvements fall within the scope of the claimed invention.

We claim:

1. A standardized method of quantum state verification based on optimal strategy, comprising:
Step 1. The target state |ψ [symbol] is generated by adjusting the quantum device. The coincidence count is measured through the time-correlated detector module, and the weight and phase of the quantum state are adjusted through the instruments adjustable parameters. During the adjustment, the ratios of coincidence count for different channels are varied, so that the weight of the target state and the coincidence count ratio are consistent as well as the phase is compensated. Finally the instrument settings that produces the target state are determined;
Step 2: Record the coincidence counts under Pauli's complete measurement base, optimize the density matrix of the target state, and estimate the value of the weight and phase parameters in the target state. In this step, you can also directly set the weight and phase of the target state required by the customer;
Determine the projective measurements {p₁M₁, p₂M₂, . . . , pᵢMᵢ, . . . , p_{N}M_{N}} of the optimal strategy in the quantum state analyzer, and calculate the setting parameters of non-adaptive measurement (Mᵢ [symbol] Pᵢ) or adaptive measurement (Mᵢ [symbol] Tᵢ) required in the quantum state analyzer according to the expression of Mᵢ in advance;
Step 3. Set up the non-adaptive measurement apparatus, use the setting parameters of the quantum device determined in step 1 to generate copies of the specific state σᵢ one by one, and perform the non-adaptive projective measurements {p₁P₁, p₂P₂, . . . , pᵢPᵢ, . . . , p_{N}P_{N}} on σᵢ. At the same time, execute coincidence counts through the time correlation counting module, and record the timetag data of each projective measurement base Pᵢ;
Build the adaptive measurement apparatus using an externally-triggered instrument, characterize and set the trigger instrument according to the parameters of the adaptive measurement calculated in step 2, and use the electrical signal output from the logic array to control the triggering device to implement classical communication between the two subsystems, and perform the adaptive measurement sets {p₁T₁, p₂T₂, . . . , pᵢTᵢ, . . . , p_{N}T_{N}};
According to the expression of adaptive measurement, the triggering device can be adjusted independently to realize the respective projective measurement. The overall adaptive measurement Tᵢ can be performed by combing the different triggering devices. Realize real-time control of projective base of particle B according to the measurement result of particle A, and record the timetag data under each projective base Tᵢ;
According to the timetag data, make programming to extract a single coincidence count. The time stamp corresponding to each channel is separated firstly, and then the time is sliced. The coincidence count is scanned from the initial time slice to the final time slice;
If there is only one coincidence count, record the corresponding coincidence channel, and iterate to the next time slice until all single coincidence counts are found, and record all the time slices and coincidence channel data corresponding to each single coincidence count, and save them in the form of a data table by column.
At the same time, if the coincidence channel falls on the channel corresponding to the successful projective measurement, it is recorded as success 1, otherwise it is recorded as failure 0, and the data of success 1 and failure 0 are also stored as a column in the data table;
Step 4: The projective measurement Pᵢ/Tᵢ is selected randomly according to the probability pᵢ corresponding to each projective base in the measurement sets, which is used to simulate the random measurement process, and then the statistical process of task A and task B is performed;
Task A performs tests on the generated quantum state from front to back, and obtains the projective measurement results of each copy according to the success probability of each coincidence channel. If success, the data 1 is recorded, while 0 is recorded for failure. When 0 appears for the first time, the subsequent projective measurement is terminated, and the index N_{first} of the first failure event is recorded. This process is cycled for 10000 rounds. In each round, the index of the occurrence of first failure event is recorded. Finally, a geometric probability distribution are determined for the index that fails for the first time. The data extraction for the first failure event can be made simultaneously for both non-adaptive and adaptive measurements;
Task B fixes the number of tests N, and selects Pᵢ/Tᵢ from the measurement sets with probability pᵢ each time. Likewise, the measurement result is obtained as 1 for success or 0 for failure through the coincidence count. Finally, the binary sequence 11101011011 . . . 1 is obtained. After making statistics on the sequence, the number of success events mₚₐₛₛ in the N times can be obtained. This process for extracting the number of success events in N times can also be performed simultaneously for the non-adaptive and adaptive measurements;
Step 5. The first failure index N_{first} in task A will constitute a geometric distribution, and the cumulative probability is the confidence:
$${δ}_{A} = {\sum }_{{N}_{first} = 1}^{{n}_{exp}} Pr ( {N}_{first} )$$
Calculate the number of measurements nₑₓₚ required for the cumulative probability to reach 90%. Fitting the probability distribution to obtain an estimate of the infidelity of the quantum state ∈ₑₓₚ. According to the fitted ∈ₑₓₚ, a suitable ϵ parameter is given, and the theoretical success probability μ=1−Δ_{∈}0 is obtained. The equipment is divided into two categories according to the chosen ϵ, one is Case 1: [symbol] ψ|σᵢ|ψ [symbol] >1−∈, the other is Case 2: [symbol] ψ|σᵢ|ψ [symbol] ≤1−∈, which is in correspondence with the results mₚₐₛₛ>μN and mₚₐₛₛ<μN, respectively. Then the Chernoff bound in probability theory:
$$δ ≡ {e}^{- ND ( \frac{{m}_{pass}}{N} \vert \vert μ )}$$
is used to estimate the variation of confidence level 1−δ and fidelity 1−ϵ versus the number of copies of quantum states N.
